(19) United States
(12) Patent Application Publication
(10) Pub. No.: US 2011/0251837 A1
(43) Pub. Date: Oct. 13, 2011

(54) ELECTRONIC REFERENCE INTEGRATION WITH AN ELECTRONIC READER

(75) Inventors: Garth CONBOY, La Jolla, CA (US); Vincent Le Chevalier, San Jose, CA (US); John Rivlin, Palo Alto, CA (US)

(73) Assignees: eBook Technologies, Inc., La Jolla, CA (US); Skiff LLC, New York, NY (US)

(21) Appl. No.: 12/755,837

(22) Filed: Apr. 7, 2010

(51) Int. Cl. G06F 17/27

(52) U.S. Cl. 704/8

(57) ABSTRACT

A system for and method of electronic reference integration with an electronic reader is presented. The system and method may include providing an electronic reference on an electronic paper display device. The method may include receiving, on an electronic paper display device, a request for an electronic reference, the request being associated with electronic content of the electronic paper display device, determining a context of the request within the electronic content, identifying a language of the electronic content based on the context, identifying an electronic reference corresponding to the identified language, and providing the electronic paper display device with access to the identified electronic reference.

### BACKGROUND INFORMATION

An electronic reader such as, for example, electronic paper display device is capable of displaying a large amount of media including e-books, electronic periodicals, newsletters, illustrations, graphics, and other electronic media. A user of an electronic reader encounters words, terms, abbreviations, symbols, and other data that they are unfamiliar with. The terms may be specialized (e.g., industry specific acronyms) or they may be presented in one or more languages foreign to a user. The level of difficulty a user encounters while attempting to identify a reference and gain an understanding of the unfamiliar data detracts from the users reading experience and increases the likelihood that a user will not gain an understanding of the unfamiliar data.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram of a system for electronic reference integration with an electronic reader according to an embodiment;

FIG. 2 shows a module for electronic reference integration with an electronic reader in accordance with an embodiment; and

FIG. 3 is a flow chart illustrating electronic reference integration with an electronic reader in accordance with an embodiment.

### DETAILED DESCRIPTION OF PREFERRED EMBODIMENTS

Certain embodiments of the present invention provide methods and systems for electronic reference integration with an electronic device. More particularly, certain embodiments of the present invention provide a system for and method of electronic reference integration with an electronic reader which may allow a user of the electronic reader easy navigation to the electronic reference from electronic content on the electronic reader.

According to an exemplary embodiment, a hardware implemented method for providing an electronic reference on an electronic paper display device may be provided. The method may include receiving, on an electronic paper display device, a request for an electronic reference, the request being associated with electronic content of the electronic paper display device, determining a context of the request within the electronic content, identifying a language of the electronic content based on the context, identifying an electronic reference corresponding to the identified language, and providing the electronic paper display device with access to the identified electronic reference.

Any electronic device having a display that can render electronic content or images may be used. In one embodiment, electronic device 100 may be an electronic reading device. Examples of electronic reading devices include electronic book readers, electronic newspaper readers, electronic paper readers, etc. Examples of an electronic display device are disclosed in U.S. patent application Ser. No. 12/481,677, entitled “Flexible Electronic Device And Method Of Manufacture”; U.S. patent application Ser. No. 12/248,331, entitled “Foldable Media Device,” U.S. patent application Ser. No. 12/332,860, entitled “Touch Sensitive Illuminated Display”; U.S. patent application Ser. No. 12/549,785, entitled “Thin Reader Device”; and U.S. patent application Ser. No. 12/574,721 entitled “Always On Reader Device.” The disclosures of each of these patent applications is incorporated, by reference, in its entirety.

Other examples of electronic devices include computers (desktops, notebooks, laptops, tablets, webbooks, netbooks, etc.), personal digital assistants (PDAs), digital cameras, digital picture frames, music players, portable video players, video game players, telephones, mobile telephones, etc.

Other related disclosures include U.S. Patent Appl'n Ser. No. 60/978,748, entitled “Content Distribution And Preloading”; U.S. patent application Ser. No. 12/481,336, entitled “System And Method For Providing Spatial And Temporal Content In An Electronic Device”; U.S. patent application Ser. No. 12/481,705, entitled “System And Method For Providing Sub-Publication Content in An Electronic Device”; U.S. patent application Ser. No. 12/481,306, entitled “Electronic Paper Display Device Event Tracking”; U.S. patent application Ser. No. 12/481,365, entitled “System And Method For Delivering Publication Content To Reader Devices Using Mixed Mode Transmission”; U.S. patent application Ser. No. 12/575,009 entitled “Electronic Advertisement Placement”; U.S. patent application Ser. No. 12/481,365 entitled “System And Method For Delivering Publication Content To Reader Devices Using Mixed Mode Transmission”; and U.S. patent application Ser. No. 12/639,512 entitled “System And Method For Rendering Advertisements On An Electronic Device.” The disclosures of each of these patent applications is incorporated, by reference, in its entirety.

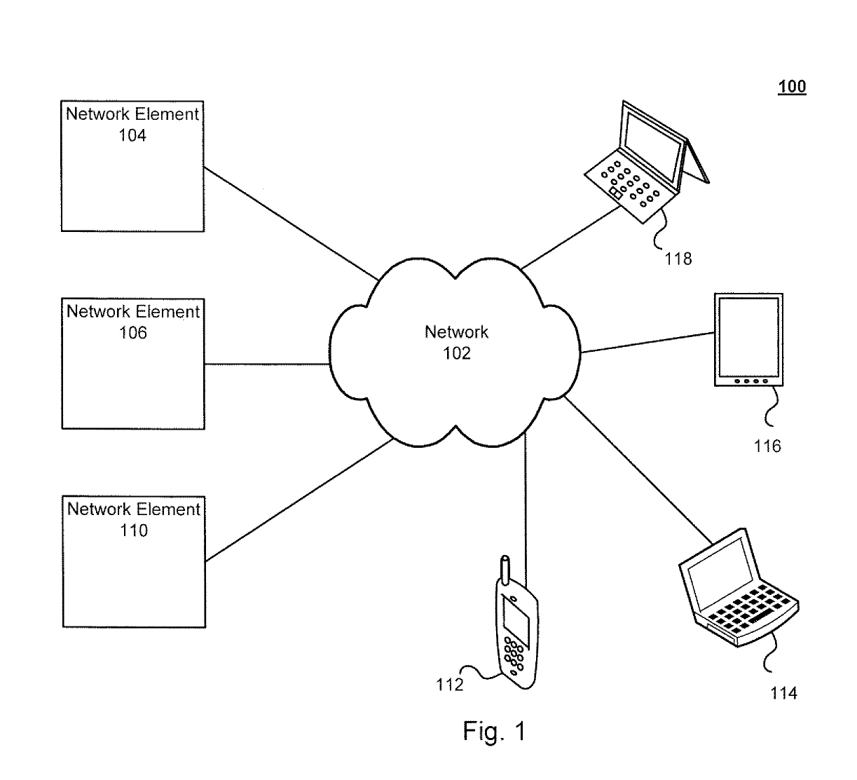

FIG. 1 is a schematic diagram of a system for electronic reference integration with an electronic reader according to an embodiment. Network elements 104, 106, and 110 may be communicatively coupled to network 102. One or more of electronic devices 112, 114, 116, and 118 may be communicatively coupled to network 102. In one or more embodiments, an electronic paper display device, such as electronic paper display device 116, may at times not be connected to a network.

Network 102 may be a wireless network, a wired network or any combination of wireless network and wired network. For example, network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n, and 802.11g or any other wired or wireless network that permits communication between network elements 104, 106, and 110, electronic devices 112, 114, 116, and 118, and other devices communicatively coupled to network 102. In addition, network 102 may include, without limitation, telephone line, fiber optics, IEEE Ethernet 802.3, a Wide Area Network (“WAN”), a Local Area Network (“LAN”), or a global network such as the Internet. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from other protocols to one or more protocols of network devices. Although network 102 is depicted as one network, it should be appreciated that according to one or more embodiments, network 102 may comprise a plurality of interconnected networks, such as, for example, a service provider network, the Internet, a publisher's network, an electronic content provider network, corporate networks, and home networks.

In one or more embodiments, network 102 may be used to distribute electronic content. Exemplary content distribution networks are disclosed in U.S. application Ser. No. 12/248,482, titled “Systems, Methods and Apparatus for Content Distribution,” filed on Oct. 9, 2008 and U.S. provisional application No. 60/978,748, titled “Content Distribution and Preloading,” filed on Oct. 9, 2007; the contents of both applications are hereby incorporated by reference in their entireties.

Network elements 104, 106, and 110 may be servers, network storage devices, or other devices communicatively coupled to network 102. In one or more embodiments, network elements 104, 106, and 110 may perform any, or a combination, of receiving electronic content display information, receiving electronic reference data, receiving requests for electronic references, translating one or more portions of electronic references between languages, communicating with external search engines and resources to identify and obtain electronic references, categorizing electronic references, parsing one or more electronic reference requests, storing rating information associated with one or more electronic references, and obtaining and generating electronic reference statistics (e.g., usage, downloads, purchases). Network elements 104, 106, and 110 may also perform any, or a combination, of storing, receiving, transmitting, producing, aggregating, and uploading electronic content. Network elements 104, 106, and 110 may also perform other electronic content management functionality including, but not limited to any, or a combination, of account management, target marketing of electronic content to electronic paper display device users (e.g., electronic references), user electronic content tracking, and content distribution. According to one or more embodiments, one or more portions of the above functionality may be performed by electronic devices 112, 114, 116, and 118.

Network elements 104, 106, and 110 may contain or be communicatively coupled to storage, such as a Redundant Array of Inexpensive Disks (“RAID”), a Storage Area Network (“SAN”), an internet Small Computer Systems Interface (“iSCSI”) SAN, a Fibre Channel SAN, a Common Internet File System (“CIFS”), Network Attached Storage (“NAS”), a Network File System (“NFS”), tape drive based storage, or other computer accessible storage.

Network elements 104, 106, and 110 communicate with any, or a combination, of other systems, applications, and storage locations directly via one or more of an Application Programming Interface (“API”), a Remote Procedure Call (“RPC”), an interface table, a web service, an Extensible Markup Language (“XML”) based interface, a Simple Object Access Protocol (“SOAP”) based interface, a Common Object Request Broker Architecture (“CORBA”) based interface, and other interfaces for sending or receiving information. For example, network elements 104, 106, and 110 may communicate with accounting systems, marketing systems, Interactive Voice Response (“IVR”) systems, systems of content providers, or other systems, servers, or components to facilitate electronic content management, electronic reference integration, electronic reference transactions (e.g., purchase of an electronic reference), formatting, and layout.

According to some embodiments, network elements 104, 106, and 110 may each be responsible for different functionality in an electronic content distribution and management network. By way of non-limiting example, network element 104 may produce, receive, organize and aggregate electronic content, such as periodicals, books, newsletters, or other electronic content. Such electronic content may be aggregated from one or more feeds, such as publishers, resellers, newspapers, journalists, news services, broadcasts, or other sources. Processing of electronic content may include any, or a combination, of indexing, categorizing, storing, formatting, translating, filtering, spell checking, compressing, encrypting, securing, replicating, and further processing. Electronic content may be produced by user or third-party input (e.g., blogs, newsletters, etc.). Such content may be input via, by way of non-limiting example, typed input or dictations processed by speech to text input (e.g., text of speeches, conferences, proceedings, hearings, etc.). Electronic content may be produced by scanning existing text, such as by way of non-limiting example, by Optical Character Recognition (“OCR”) processes. Other scanning processes may produce electronic content without performing OCR processes. Network element 104 may translate content from one format to another. For example, network element 104 may receive content from a subscriber and may translate the content into one or more electronic formats including, but not limited to, proprietary formats or industry standard formats (e.g., EPub (Electronic Publication)) utilized by one or more e-book readers. Network element 104 may receive subscriber or user content via emails, FTP (“File Transfer Protocol”), HTTP (“Hyper Text Transfer Protocol”), text message (e.g., via Short Message Service (“SMS”)), Multi-Media Messaging Service (“MMS”), Wireless Access Protocol (“WAP”), or via other electronic communication protocols. Categorization of content by network element 104 may include any, or a combination, of organizing content, storing content, and indexing content by one or more of a subject, subscription, and access. By way of non-limiting example, content may be grouped or stored in databases or other storage which may be separated according to subscription.

According to one or more embodiments, network element 104 may perform one or more additional functionalities. For example, network element 104 may contain or access one or more of user subscription information, accounting information, payment information, account identification, and statistics associated with user access to one or more portions of electronic content. Network element 104 may interface to other systems or components, either local or remote, such as accounting systems, Customer Relationship Management (“CRM”) systems, marketing systems, payment systems, authentication systems, network access servers, or other network systems or components. Network element 104 may monitor one or more accounts and may monitor access to electronic content stored on, distributed by or accessible from network 102 or one or more devices communicatively coupled to network 102. Account information may be provided to network element 104 or other network accessible components to generate usage information, verify transactions, or for other functionality. Subscription information, usage agreement information, and registration information obtained from a user of an electronic content network may contain demographic information, preference information, or other information which may be utilized for marketing purposes.

According to one or more embodiments, network element 106 may perform any, or a combination of receiving a request for an electronic reference from an electronic reader, determining a context of a request within associated electronic content, identifying a language of the electronic content based at least in part on the context of the request, identifying an electronic reference corresponding to the identified language, and providing access to an electronic reference. For example, a user of and electronic reader such as, for example, electronic devices 112, 114, 116, and/or 118, may be reading electronic content when they encounter a word, symbol, graphic, or other data that they are unfamiliar with or desire more about. The user may provide input requesting a reference providing more information about one or more portions of the electronic content. By way of non-limiting example, a user may tap a word, symbol or another portion of electronic content displayed on an electronic reader and network element 106 may receive an electronic reference request. An electronic reference request may include a selected portion of electronic content as indicated by a user. According to one or more embodiments, an electronic reference request may include context of the electronic reference request such as, for example, additional data surrounding a portion of data (e.g., the sentence, paragraph, page, document, or file containing the selected portion of data), metadata (e.g., tags or other data in proximity to the selected data), graphics within a specified proximity of the data, symbols within a specified proximity of the data, and accent marks or indicators associated with the portion of data. Network element 106, according to some embodiments, may parse one or more portions of a context of the request to identify a language associated with the request. For example, network element 106 may parse one or more words of a request to identify a conjugation of a word, a root of a word, an accent indicator (e.g., the French grave accent mark or a Spanish acute accent mark), an article associated with a language (e.g., Le), or a pronoun associated with a language. Network element 106 may query one or more references to identify references containing words associated with an electronic reference request. According to some embodiments, if more than a specified percentage of words in an electronic reference request are contained in a reference, the language of the reference may be determined to be the language of the electronic reference request.

Network element 106 may translate portions of one or more references to an identified language. For example, if an electronic reference, such as a definition, is requested for a portion of an English electronic text and a reference is not available, network element 106 may utilize a translation of a German reference to provide a definition. According to some embodiments, network element 106 may also translate a reference to a default language or to a user preferred language. For example, if a user's default or preferred language is Japanese, even though the electronic text and an identified reference are in English, one or more portions of the reference corresponding to the electronic reference request may be provided in Japanese. In another example, the electronic content on the electronic reader may be in English, the user's preferred language may be Japanese, and the relevant reference may be in German. Network element 106 may provide one or more relevant portions of the German reference to the user translated into Japanese.

Network element 106 may search for electronic references stored on the electronic paper display device, on network element 106, or in other network accessible locations. Network element 106 may query one or more search engines and may download or provide location information of one or more external references. For example, network element 106 may provide the electronic paper display device with access to the identified electronic reference including one or more of: providing a link to the identified electronic reference, providing a file system path to the identified electronic reference; opening a window on the electronic paper display device containing the identified electronic reference, downloading the identified electronic reference, and providing an Application Programming Interface (API) to access the identified electronic reference.

In addition to one or more of identifying a language associated with a electronic content request, identifying a language associated with a user, and/or identifying an electronic reference, network element 106 may perform other functionality. For example, network element 106 may identify a category associated with an electronic reference request. A category may be used to group electronic references by a type such as, for example, medical, legal, technical, government, translation, thesaurus, dictionary, and atlas. A category may be associated with an electronic document and a search for a reference may use that category (e.g., medical or legal). A user may be prompted or may specify a category when requesting an electronic reference (e.g., a dictionary, a thesaurus, or an atlas). A category may be used to filter, order, or rank electronic reference search results.

Other factors may be provided by a user or an electronic display device that may further identify, rank, filter, or order electronic references. An electronic reference may have an associated rating, usage statistics may be associated with a reference, and a user of an electronic paper display device may have specified preferences.

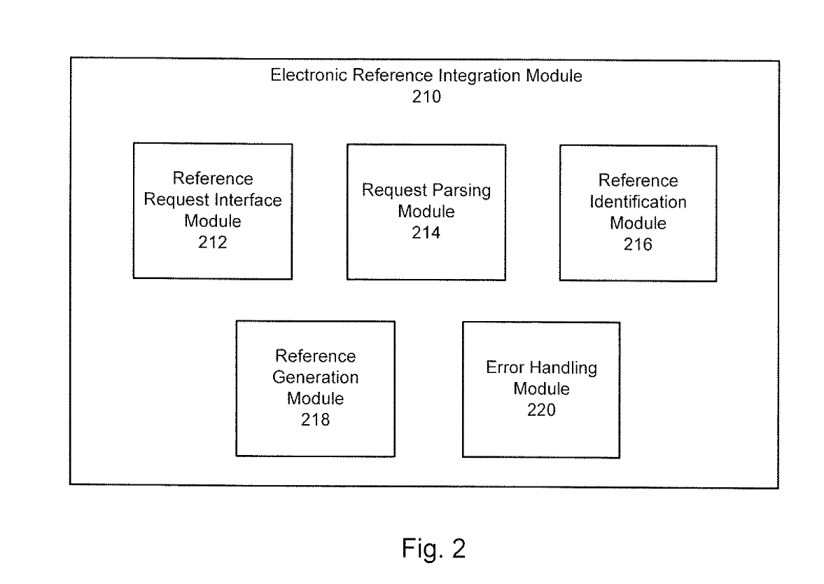

According to some embodiments, one or more portions of functionality or all functionality of network element 106 may be performed on an electronic reader. An electronic reader may contain one or more modules performing electronic reference integration with an electronic reader as discussed in further detail with reference to FIG. 2 below. One or more of electronic devices 112, 114, 116, and 118 may receive a request for an electronic reference from a user input, determine a context of a request within associated electronic content, identify a language of the electronic content based at least in part on the context of the request, identify an electronic reference corresponding to the identified language, and providing access to an electronic reference. Electronic devices 112, 114, 116, and 118 may contain one or more references stored locally and may provide access to references such as, for example, thesauruses and dictionaries. Electronic devices 112, 114, 116, and 118 may provide access to electronic references without requiring network access or access to external devices.

According to some embodiments, electronic devices 112, 114, 116, and 118 may parse one or more portions of a context of a request to identify a language associated with the request. For example, electronic devices 112, 114, 116, and 118 may parse one or more words of a request to identify a conjugation of a word, a root of a word, an accent indicator (e.g., the French grave accent mark or a Spanish acute accent mark), an article associated with a language (e.g., Le), or a pronoun associated with a language. Electronic devices 112, 114, 116, and 118 may query one or more references to identify references containing words associated with an electronic reference request. Electronic devices 112, 114, 116, and 118 may translate portions of one or more references to an identified language.

According to some embodiments, in the event a reference is unavailable locally, electronic devices 112, 114, 116, and 118 may store a request until network access is available. When network access is available, electronic devices 112, 114, 116, and 118 may retrieve, request, or access an external reference and may provide reference information to a user to the electronic reader.

One or more electronic references identified may be available only to purchasers of the reference. According to some embodiments, an electronic paper display device may provide a user interface allowing a user to purchase an electronic reference. An electronic paper display device may receive an input from a user of the electronic paper display device accepting the offer to purchase an electronic reference, may install the electronic reference for use by the user, and may respond to a request for an electronic reference by displaying a portion of the electronic reference associated with the request.

If an electronic reference request is received for which no reference is identified or for which the identified reference is not satisfactory, a user may create an electronic reference. An electronic paper display device may provide a user interface allowing a user to create a custom reference. The user may select one or more terms in the electronic content and tap the screen, select a menu choice, or provide another input to select an option to create a custom reference containing the terms or to add the terms to an existing custom reference. For example, the terms may be field specific acronyms in a work related electronic document of the user. The user may add one or more terms to a custom reference and may be given an opportunity to edit data associated with the terms such as, for example, a dictionary definition of the terms or synonyms listed in a thesaurus. The user may consult a paper copy of a reference, a co-worker, or another source of information, and may input a definition for one or more terms. According to some embodiments, a user may share, receive, and/or transmit a custom electronic reference. For example, a user may create a custom electronic reference for a group at work that may be shared with or transmitted to one or more members of a group.

Electronic devices 112, 114, 116, and 118 may be electronic book (“e-book”) readers, E-ink® devices, desktop computers, laptop computers, wireline phones, mobile phones, Personal Digital Assistants (“PDA”), personal media players, gaming devices, or other devices capable of displaying electronic content. In one or more embodiments, electronic devices 112, 114, 116, and 118 may access electronic content locally via one or more device interfaces.

Electronic devices 112, 114, 116, and 118 may perform one or more of rendering and displaying electronic content containing layout markup, tags, or other formatting control structures. Electronic devices 112, 114, 116, and 118 may receive electronic content and may display electronic content using layout markup, tags, or other formatting control structures. Electronic devices 112, 114, 116, and 118 may display only the primary electronic content, or the primary electronic content and one or more additional elements.

According to some embodiments, electronic devices 112, 114 116, and 118 may access electronic content and receive and/or transmit electronic content via one or more network interfaces. Electronic devices 112, 114, 116, and 118 may transmit and receive data to and from network 102 utilizing a standard telecommunications protocol or a standard networking protocol. By way of non-limiting example, one embodiment may utilize FTP (“File Transfer Protocol”), HTTP (“Hyper Text Transfer Protocol”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Transmission Control Protocol/Internet (“TCP/IP”) Protocols, or other protocols or systems suitable for transmitting and receiving electronic content data. Electronic content may be transmitted and received wirelessly or may utilize cabled network or telecom connections such as an Ethernet R145/Category 5 connection, a fiber connection, a traditional phone wireline connection, a cable connection or other wired network connection. Electronic devices 112, 114, 116, and 118 may use standard wireless protocols including IEEE 802.11 and 802.16. Electronic devices 112, 114, 116, and 118 may also be connected to network 102 via protocols for a wired connection, such as an IEEE Ethernet 802.3.

By way of non-limiting example, electronic devices 112, 114, 116, and 118 may contain one or more interfaces including, a USB (“Universal Serial Bus”) connection, an RS-232 or serial connection, a Bluetooth connection, an RFID (“Radio Frequency IDentification”) reader or interrogator, an RFID tag (active or passive), a firewire connection, or interfaces supporting storage media (e.g., flash memory cards, CDs, DVDs).

Network element 110 may provide electronic content to electronic devices 112, 114, 116, and 118. Network element 110 may also collect information from electronic devices 112, 114, 116, and 118, such as electronic reference request data. For example, network element 110 may generate statistics on requested references, available references, reference usage, reference purchases, and generation of custom electronic references.

FIG. 2 shows electronic reference integration module 210 in accordance with an embodiment of the present disclosure. Electronic reference integration module 210 may contain one or more components including reference request interface module 212, request parsing module 214, reference identification module 216, reference generation module 218, and error handling module 218. One or more portions of electronic reference integration module 210 may be located on a user device, such as an electronic paper display device. According to some embodiments, one or more portions of electronic reference integration module 210 may be located on a network element. According to one or more embodiments, all portions of electronic reference integration module 210 may be located on an electronic reader.

Reference request interface module 212 may provide one or more interfaces, APIs, or other mechanisms for an electronic reader to integrate an electronic reference with electronic content on the reader. Reference request interface module 212 may allow a user to seamlessly perform one or more of requesting an electronic reference, selecting an electronic reference, purchasing an electronic reference, creating a custom electronic reference, and accessing a electronic reference. Reference request interface module 212 may allow a user to access menus (e.g., when a displayed term is tapped on or otherwise selected by a user) from an electronic reader. The menus may provide a reference in a second window which may allow a user to view electronic content as well as a corresponding requested electronic reference.

Request parsing module 214 may receive an indicator from a user such as a tap on a portion of data displayed on an electronic display device. The portion of data may be received (e.g., a selected word) and additional data providing context of the portion of data may also be received. For example, metadata of an electronic document containing the term may be received or queried by request parsing module 214. The metadata may indicate one or more user preferences, document settings, or other settings. For example, metadata may indicate the language of an electronic document and the preferred or default language of a user. According to some embodiments, contextual data may include text, graphics, or other data in close proximity to a selected word. For example, request parsing module 214 may receive or query one or more portions of a sentence, paragraph, or document containing a user selected word. The contextual data may be parsed to determine a language of an electronic document, a category of an electronic document, or other factors useful for identifying an electronic reference. Parsing of electronic data may include identifying a word stem, a conjugation, an accent mark, or another portion of text associated with a language. Parsing of electronic data may also include parsing a portion of text to identify an article associated with a language (e.g., Le or La), a pronoun associated with a language, or another characteristic of the text indicative of a particular language. Network element 106 may query one or more references to identify references containing words associated with an electronic reference request. According to some embodiments, if more than a specified percentage of words in an electronic reference request are contained in a reference, the language of the reference may be determined to be the language of the electronic reference request.

Reference identification module 216 may search for electronic references stored on the electronic paper display device, on network element 106, or in other network accessible locations. Reference identification module 216 may query one or more search engines and may download or provide location information of one or more external references. For example, reference identification module 216 may provide the electronic paper display device with access to the identified electronic reference including one or more of: providing a link to the identified electronic reference, providing a file system path to the identified electronic reference, downloading the identified electronic reference, opening a window on the electronic paper display device containing the identified electronic reference, and providing an Application Programming Interface (API) to access the identified electronic reference.

In addition to one or more of identifying a language associated with an electronic content request, identifying a language associated with a user, and/or identifying an electronic reference, reference identification module 216 may perform other functionality. For example, reference identification module 216 may identify a category associated with an electronic reference request. A category may be used to group electronic references by a type such as, for example, medical, legal, technical, government, translation, thesaurus, dictionary, and atlas. For example, a category may be associated with an electronic document and a search for a reference may use that category (e.g., medical or legal). A user may be prompted or may specify a category when requesting an electronic reference (e.g., a thesaurus, a dictionary, and an atlas). A category may be used to filter, order, or rank electronic reference search results.

Other factors may be provided by a user or an electronic display device that may further identify, rank, filter, or order electronic references. An electronic reference may have an associated rating, usage statistics may be associated with a reference, and a user of an electronic paper display device may have specified preferences.

Reference identification module 216 may provide a user interface allowing a user to purchase an electronic reference. An electronic paper display device may receive an input from a user of the electronic paper display device accepting the offer to purchase an electronic reference, and reference identification module 216 may install the electronic reference for use by the user.

Reference identification module 216 may also translate portions of one or more references to an identified language. Reference identification module 216 may translate a reference to a default language or to a user preferred language.

Reference generation module 218 may allow the generation of an electronic reference by a user. For example, if an electronic reference request is received for which no reference is identified or for which the identified reference is not satisfactory, a user may create an electronic reference. Reference generation module 218 may provide a user interface allowing a user to create a custom reference. The user may select one or more terms in the electronic content by tapping and may choose a menu entry or provide another input to request their addition to an electronic reference. The user may be provided with an option to create a custom reference containing the terms or to add the terms to an existing custom reference. For example, the terms may be field specific acronyms in a work related electronic document of the user. The user may add one or more terms to a custom reference and may be given an opportunity to edit data associated with the terms such as, for example, a dictionary definition of the terms or synonyms listed in a thesaurus. The user may consult a paper copy of a reference, a co-worker, or another source of information and may input a definition for one or more terms. According to some embodiments, a user may share, receive, and/or transmit a custom electronic reference. For example, a user may create a custom electronic reference for a group at work that may be shared with or transmitted to one or more members of a group.

Error handling module 220 may handle errors associated with electronic reference integration for an electronic paper display device. Error handling module 220 may log errors, send notifications, or perform corrective actions. For example, error handling module 220 may handle errors identifying a reference, a language associated with an electronic reference request, purchase of an electronic reference, and access of an electronic reference. Error handling module 220 may also allow logging of an error or retrying one or more actions.

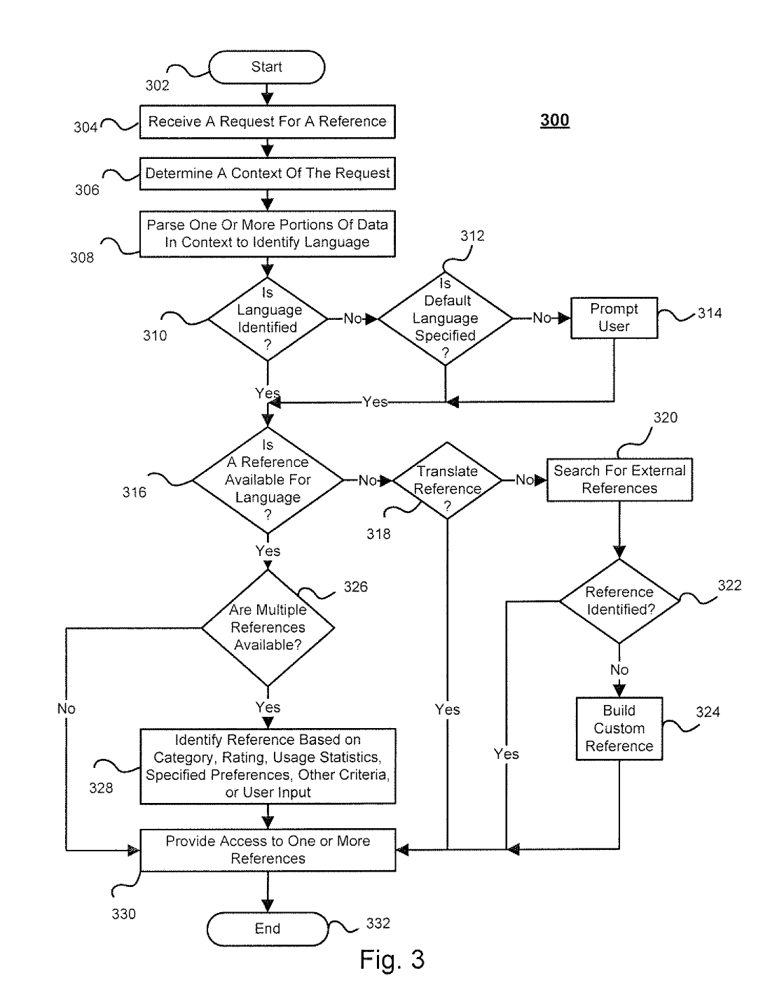

FIG. 3 is a flow chart illustrating electronic reference integration with an electronic reader in accordance with an embodiment according to an embodiment. At block 302, the method 300 for electronic reference integration, in accordance with an exemplary embodiment, may begin.

At block 304, the method 300 may receive a request for an electronic reference.

At block 306, a context of the request may be determined. One or more portions of electronic content associated with the request for an electronic reference may be used to determine the context. For example, if a user taps a word on a page of an electronic book and selects a menu choice for an electronic reference, one or more portions of the electronic book may be transmitted to provide context along with the indicated word. Transmitted portions may include the sentence of the word, the paragraph of the word, the page of the word, and metadata from one or more portions of the electronic book. Metadata may include, for example, a language of the electronic book, a title of the electronic book, a category of the electronic book, and an author of the electronic book. Other data may be provided to determine the context of the request. Other contextual data may include data from an electronic reader such as, for example, user specified preferences.

At block 308, one or more portions of data may be parsed in the context of the electronic reference request to identify a language associated with the electronic reference request. Parsing data may include parsing metadata to identify keywords, parsing a user indicated word (e.g., word stemming, conjugating, etc.), identifying portions of electronic text associated with a language, identifying portions of text associated with a category, and parsing a user inputted response to a prompt.

At block 310, it may be determined whether a language has been identified. If a language has been identified, the method 300 may continue at block 316. If a language has not been identified, the method 300 may continue at block 312.

At block 312, the method may determine whether a default language is specified. A default language may be specified for one or more of a user, an electronic reader, and an electronic document. If a default language is identified, the method 300 may continue at block 316. If a default language is not identified, the method 300 may continue at block 314.

At block 314, a user may be prompted to specify a language for a reference.

At block 316, the method 300 may determine if a reference is available for the identified language. If a reference is available for the identified language, the method 300 may continue at block 326. If a reference is not available for the identified language the method 300 may continue at block 318.

At block 318 if a reference is available in a language other than the identified language of the electronic content or of the user, one or more portions of the reference may be translated. If a reference is identified and translated to the language of the electronic document display on an electronic reader or to the preferred language of the user, the method 300 may continue at block 330. If a reference is not available in another language or a translation is not available, the method may continue at block 320.

At block 320, a search for one or more external references may begin. One or more search engines, websites, or external servers may be queried for an electronic reference. One or more electronic references identified may be available only to purchasers of the reference. According to some embodiments, an electronic paper display device may provide a user interface allowing a user to purchase an electronic reference. An electronic paper display device may receive an input from a user of the electronic paper display device accepting the offer to purchase an electronic reference, may install the electronic reference for use by the user, and may respond to a request for an electronic reference by displaying a portion of the electronic reference associated with the request.

At block 322, if an electronic reference is identified, the method 300 may continue at block 330. If no suitable electronic references are identified, the method 300 may continue at block 324.

At block 324 a user may be provided with an interface to build a custom reference. The user may select one or more terms in displayed electronic content by tapping and may choose a menu entry or provide another input to request their addition to an electronic reference. The user may be provided with an option to create a custom reference containing the terms or to add the terms to an existing custom reference. For example, the terms may be field specific acronyms in a work related electronic document of the user. The user may add one or more terms to a custom reference and may be given an opportunity to edit data associated with the terms such as, for example, a dictionary definition of the terms or synonyms listed in a thesaurus. The user may consult a paper copy of a reference, a co-worker, or another source of information and may input a definition for one or more terms. According to some embodiments, a user may share, receive, and/or transmit a custom electronic reference. For example, a user may create a custom electronic reference for a group at work that may be shared with or transmitted to one or more members of a group.

At block 326, if multiple electronic references are identified, the method may continue at block 328. If only one electronic reference is identified, the method may continue at block 330.

At block 328, one or more factors may be used to select, order, rank, and/or filter identified electronic references. For example, a category associated with an electronic reference request may be used to group electronic references by a type such as, for example, medical, legal, technical, government, translation, thesaurus, dictionary, and atlas. A category may also be associated with an electronic document and a search for a reference may use that category (e.g., medical or legal). A user may be prompted or may specify a category when requesting an electronic reference (e.g., a thesaurus, a dictionary, or an atlas). A category may be used to filter, order, or rank electronic reference search results.

Other factors may be provided by a user or an electronic display device that may further identify, rank, filter, or order electronic references. An electronic reference may have an associated rating, usage statistics may be associated with a reference, and a user of an electronic paper display device may have specified preferences. If an electronic reference is to be purchased, cost may be a factor used to filter, order, or rank electronic references. Other factors may include the provider of the reference (e.g., a publisher, a website, and/or a company) and the format of the reference.

At block 330, access may be provided to one or more electronic references. References may be downloaded or location information provided to one or more external references. For example, providing access may include one or more of providing a link to the identified electronic reference, providing a file system path to the identified electronic reference, opening a window on the electronic paper display device containing the identified electronic reference, and providing an Application Programming Interface (API) to access the identified electronic reference.

At block 332, the method may end.

The description above describes one or more devices including user devices, a communication network having network elements that are coupled to each other via one or more links (e.g., physical or logical), a communication network, and other elements for coupling users to the communication network, some of which are explicitly depicted, others of which are not. As used herein, the term “module” may be understood to refer to executable software, firmware, hardware, or various combinations thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

It is further noted that the software described herein may be tangibly embodied in one or more physical media, such as, but not limited to, a Compact Disc (“CD”), a Digital Versatile Disc (“DVD”), a floppy disk, a hard drive, Read Only Memory (“ROM”), Random Access Memory (“RAM”), as well as other physical media capable of storing software, or combinations thereof. Moreover, the figures illustrate various components (e.g., servers, computers, etc.) separately. The functions described as being performed by various components may be performed by other components, and the various components may be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A hardware implemented method for providing an electronic reference on an electronic paper display device, the method comprising:
receiving, on an electronic paper display device, a request for an electronic reference, the request being associated with electronic content of the electronic paper display device;
determining a context of the request within the electronic content;
identifying a language of the electronic content based on the context;
identifying an electronic reference corresponding to the identified language; and
providing the electronic paper display device with access to the identified electronic reference.

2. The hardware implemented method of claim 1, wherein identifying a language of the electronic content based on the context comprises mapping one or more words, symbols, or graphics of the electronic content associated with the request to a language.

3. The hardware implemented method of claim 2, wherein mapping a word comprises one of: parsing a word to identify a root; parsing a word to identify a conjugation; identifying an article associated with a language; and associating one or more words, other than a word in the request, with a language based on the proximity of the one or more words to a word in the request.

4. The hardware implemented method of claim 2, wherein mapping a graphic comprises parsing a graphic to identify a symbol associated with a language.

5. The hardware implemented method of claim 2, wherein identifying a language of the electronic content based on the context comprises:
identifying an electronic reference associated with a language containing one or more words within the context of the request; and
determining a probability that the electronic reference is associated with the language.

6. The hardware implemented method of claim 1, further comprising identifying a category of the electronic content associated with the request; and
identifying an electronic reference corresponding to the category of the electronic content.

7. The hardware implemented method of claim 1, further comprising:
identifying a language associated with a user of the electronic paper display device; and
translating one or more portions of a reference to the language associated with the user.

8. The hardware implemented method of claim 1, wherein identifying an electronic reference corresponding to the identified language further comprises translating one or more portions of a reference available in a language other than the identified language of the electronic content to the identified language of the electronic content.

9. The hardware implemented method of claim 1, wherein identifying an electronic reference corresponding to the identified language further comprises performing a search for one or more electronic references stored externally from the electronic paper display device.

10. The hardware implemented method of claim 9, further comprising offering one or more electronic references for purchase to a user of the electronic paper display device via the electronic paper display device.

11. The hardware implemented method of claim 1, further comprising building a custom reference containing one or more terms contained in the request for the electronic reference.

12. The hardware implemented method of claim 11, wherein the electronic paper display device provides an interface allowing a user to provide input for the custom reference.

13. The hardware implemented method of claim 1, further comprising identifying an electronic reference based on at least one of: a rating associated with a reference, usage statistics associated with a reference, specified preferences of a user of the electronic paper display device, and user input.

14. The hardware implemented method of claim 1, wherein providing the electronic paper display device with access to the identified electronic reference comprises at least one of: providing a link to the identified electronic reference, providing a file system path to the identified electronic reference; opening a window on the electronic paper display device containing the identified electronic reference, and providing an Application Programming Interface (API) to access the identified electronic reference.

15. The hardware implemented method of claim 1, wherein the electronic reference comprises one or more portions of: a dictionary, a thesaurus, an encyclopedia, an atlas, a translation, a graphic associated with the context of the request, and a directory.

16. At least one processor readable storage medium for storing a computer program of instructions configured to be readable by at least one processor for instructing the at least one processor to execute a computer process for performing the method as recited in claim 1.

17. An electronic paper display device comprising:
electronic paper display for displaying electronic content;
a communications module for receiving electronic content; and
a processor communicatively coupled to the electronic paper display and the communications module, wherein the processor is configured to:
receive, on an electronic paper display device, a request for an electronic reference, the request being associated with electronic content of the electronic paper display device;
determine a context of the request within the electronic content;
identify a language of the electronic content based on the context;
identify an electronic reference corresponding to the identified language; and
provide the electronic paper display device with access to the identified electronic reference.

18. The electronic paper display device of claim 17, wherein the processor is further configured to identify a language of the electronic content based on the context by identifying a reference associated with a language, the reference containing one or more words, symbols, or graphics of the electronic content associated with the request to a language.

19. The electronic paper display device of claim 18, wherein the processor being further configured to map a word comprises one of: parsing a word to identify a root; parsing a word to identify a conjugation; identifying an article associated with a language; and associating one or more words, other than a word in the request, with a language based on the proximity of the one or more words to a word in the request.

20. The electronic paper display device of claim 18, wherein the processor is further configured to:
identify a language associated with a user of the electronic paper display device; and
translate one or more portions of a reference to the language associated with the user.

21. The electronic paper display device of claim 18, wherein the processor is further configured to:
translate one or more portions of a reference available in a language other than the identified language of the electronic content to the identified language of the electronic content.

22. The electronic paper display device of claim 18, wherein identifying an electronic reference corresponding to the identified language further comprises performing a search for one or more electronic references stored externally from the electronic paper display device.

23. The electronic paper display device of claim 22, wherein the processor is further configured to:
receive an offer for an electronic reference for purchase to a user of the electronic paper display device via the electronic paper display device in response to the search for one or more electronic references stored externally from the electronic paper display device;
receive an input from a user of the electronic paper display device accepting the offer;
install the electronic reference for use by the user; and
respond to the request for the electronic reference by displaying a portion of the electronic reference associated with the request.

24. The electronic paper display device of claim 18, wherein the processor is further configured to provide a user interface allowing a user to build a custom reference containing one or more terms contained in the request for the electronic reference.
